(19) United States
(12) Patent Application Publication
(10) Pub. No.: US 2025/0096538 A1
(43) Pub. Date: Mar. 20, 2025

(54) WEATHER-RESISTANT RECREATIONAL VEHICLE (RV) POWER CORD CONNECTOR HOUSING

(71) Applicant: Henry Edgar Herbert, Fredericksburg, VA (US)

(72) Inventor: Henry Edgar Herbert, Fredericksburg, VA (US)

(21) Appl. No.: 18/885,983

(22) Filed: Sep. 16, 2024

Related U.S. Application Data
(60) Provisional application No. 63/536,108, filed on Sep. 18, 2023.

(51) Int. Cl. H02B 1/28; H02B 1/48; H02B 1/52

(52) U.S. Cl. CPC H02B 1/28; H02B 1/48; H02B 1/52

(57) ABSTRACT

A weather-resistant RV power cord junction housing includes a box body including a bottom and sidewalls that define an inner area, and a lid that in a closed state covers the inner area of the box body and that in an open state exposes the inner area. A first one of the sidewalls includes a first opening. A second one of the sidewalls includes a second opening. The first one of the sidewalls faces the second one of the sidewalls. The first opening is offset from the second opening. The first opening is dimensioned to receive a portion of a first power cord, and the second opening is dimensioned to receive a portion of a second power cord.

### BACKGROUND

### 1. Technical Field

An embodiment relates to a weather-resistant recreational vehicle (RV) power cord connector housing and a method of manufacture of the same.

### 2. Discussion of the Related Art

Recreational Vehicles (RVs), campers, and trailers are typically equipped with heavy-duty power cords that plug into a power source providing electricity to the RV. RV power cords are available in different configurations, including 10 AWG (copper) for 30 amp service, and 8 AWG (copper) or 6 AWG (copper) for 50 amp service. Such RV power cords are typically much thicker than common household extension cords and usually include connector plugs at both ends. In an embodiment, an RV power cord may have a thickness in a range of approximately ¾ inch (30 amp RV power cord) to approximately 1¼ inch (50 amp RV power cord), and may include one connector plug being a male end, and the other connector plug being a female end. In one non-limiting example configuration, L-shaped connector plugs are provided at both ends, where the male end L-shaped connector plug may be connected to the power source and the female end L-shaped connector plug may be connected to the RV. The connection of the power source may be part of a junction box affixed to a wall or post, and the connection of the RV may be on a wall of the RV.

While use of a single RV power cord is suitable in some situations, sometimes the RV power cord is not long enough. Accordingly, RV owners frequently may connect multiple RV power cords to reach the power source while staying at a campground, or even when the RV is parked at home. Connection of one power cord to another power cord is relatively simple and merely involves plugging the male end L-shaped connector plug of the one power cord into the female end L-shaped connector plug of the other power cord resulting in a power cord junction that may also be referred to as an S-shaped configuration. Differently configured RV power cords may be joined together using a power converter connected therebetween.

FIG. 1 is a schematic view of a 30 amp to 30 amp power cord junction 100 between a 30 amp power cord 102 and another 30 amp power cord 104. FIG. 2 is a schematic view of a 50 amp to 50 amp power cord junction 100′ between a 50 amp power cord 102′ and another 50 amp power cord 104′. FIG. 3 is a schematic view of a 50 amp to 30 amp power cord junction 100″ using a power converter 106 between a 50 amp power cord 102″ and a 30 amp power cord 104″. FIG. 4 is a schematic view of a 30 amp to 50 amp power cord junction 100″ using a power converter 106′ between a 30 amp power cord 102′″ and a 50 amp power cord 104″′. In each of FIGS. 1-4, the junction may be observed to be an S-shaped configuration.

However, as shown in FIG. 4, when two (or more) RV power cords are joined together, the junction (i.e., the joined L-shaped connector plugs) is often left on the ground and exposed to the elements. For example, as shown in FIG. 4, the junction 104″′ is partially contacting a puddle of water 110. This poses a risk of electric shock to anything in the vicinity of the junction (or junctions), especially for anyone physically handling the power cords. Further, leaving the junction exposed can lead to corrosion of the metal portions of the power cords (e.g., the plug prongs, and the metal lines within each cord), as well as introduction of dirt and other materials into the power cords. Additionally, leaving the junction exposed can invite unwanted tampering of the junction.

This background section is intended to provide context and may contain recognitions not part of the knowledge of those of ordinary skill in the art as of the effective filing date of this disclosure and is not admitted prior art.

### SUMMARY

According to an embodiment, a weather-resistant recreational vehicle (RV) power cord connector housing is provided, and may include a box body including a bottom and a plurality of sidewalls, the bottom and the plurality of sidewalls defining an inner area of the box body, and a lid that in a closed state covers the inner area of the box body and that in an open state exposes the inner area of the box body. A first one of the plurality of sidewalls may include a first opening. A second one of the plurality of sidewalls may include a second opening. The first one of the plurality of sidewalls may face the second one of the plurality of sidewalls. The first opening may be offset from the second opening. The first opening may be dimensioned to receive a portion of a first power cord, and the second opening may be dimensioned to receive a portion of a second power cord.

According to another embodiment, a method of manufacture of a weather-resistant RV power cord junction housing is provided. The method may include fabricating a box body including a bottom and a plurality of sidewalls, the bottom and the plurality of sidewalls defining an inner area of the box body, and fabricating a lid that in a closed state covers the inner area of the box body and that in an open state exposes the inner area of the box body. The fabricating of the box body including the bottom and the plurality of sidewalls may include forming a first opening in a first one of the plurality of sidewalls, and forming a second opening in a second one of the plurality of sidewalls. The first one of the plurality of sidewalls may face the second one of the plurality of sidewalls. The first opening may be offset from the second opening. The first opening may be dimensioned to receive a portion of a first power cord, and the second opening may be dimensioned to receive a portion of a second power cord.

Additional devices, systems, and methods are disclosed.

### BRIEF DESCRIPTION OF THE DRAWINGS

The above and other features of the disclosure will become more apparent by describing in detail embodiments thereof with reference to the attached drawings, in which:

FIG. 1 is a schematic view of a first power cord junction between a power cord and another power cord.

FIG. 2 is a schematic view of a second power cord junction between a power cord and another power cord.

FIG. 3 is a schematic view of a third power cord junction using a converter between a power cord and another power cord.

FIG. 4 is a schematic view of a fourth power cord junction using a converter between a power cord and another power cord.

FIG. 5 is a schematic perspective view of a weather-resistant recreational vehicle (RV) power cord connector housing according to a first embodiment.

FIG. 6 is a schematic perspective view showing a partial cutaway of the weather-resistant RV power cord connector housing of FIG. 5.

FIG. 7 is a schematic perspective view of a weather-resistant RV power cord connector housing according to a second embodiment.

FIG. 8 is a schematic front view of the weather-resistant RV power cord connector housing of FIG. 7.

FIG. 9 is a schematic side view of the weather-resistant RV power cord connector housing of FIG. 7.

FIG. 10 is a schematic plan view of the weather-resistant RV power cord connector housing of FIG. 7.

FIG. 11 is a schematic perspective view of a weather-resistant RV power cord connector housing according to a third embodiment.

FIG. 12 is a schematic perspective view of a weather-resistant RV power cord connector housing according to a fourth embodiment.

FIG. 13 is a flow chart of a method of manufacture of a weather-resistant RV power cord junction housing according to an embodiment.

### DETAILED DESCRIPTION OF THE EMBODIMENTS

In the following description, for purposes of explanation and non-limitation, specific details are set forth in order to provide an understanding of the described embodiments. It will be apparent to one skilled in the art that other embodiments may be practiced apart from the specific details disclosed below. In other instances, detailed descriptions of well-known methods, devices, techniques, etc. are omitted so as not to obscure the description with unnecessary detail.

Herein, references to a single feature are intended to capture the plural form (and vice versa), unless the context clearly indicates otherwise. The phrase “and/or” is intended to include one or more of the listed features. The terms “and” or “or” are intended to be treated similarly to “and/or”.

The expression “at least one of A and B” shall be interpreted to include all variations including A or B, including A, B, AB, AA, BB.

The terms “about,” “approximately,” and “substantially” are intended to include the stated value or values, and deviations therefrom as would be appreciated by one of ordinary skill in the art, such as 0.1 percent, 1 percent, or 10 percent of the stated value or values, and the like.

The terms “first” and “second” are intended to distinguish between elements and should not create an inference of order. For example, a first feature may instead be called a second feature, and the second feature may instead be called the first feature, and such would still be within the scope of the present disclosure.

As noted above, when two (or more) RV power cords are joined together, the junction is often left on the ground and exposed to the elements, which can lead to electric shock and undesirable corrosion of metal the metal portions of the power cords. Further, leaving the junction exposed can invite unwanted tampering of the junction.

According to an embodiment, a weather-resistant RV power cord connector housing may be provided. The weather-resistant RV power cord connector housing may secure a junction between two power cords in a weather-resistant enclosure, thereby reducing or even eliminating the likelihood of electric shock, corrosion, and tampering. According to another embodiment, a method of manufacture of a weather-resistant RV power cord connector housing is provided. The method may enable cost-effective and efficient manufacture of the weather-resistant RV power cord connector housing.

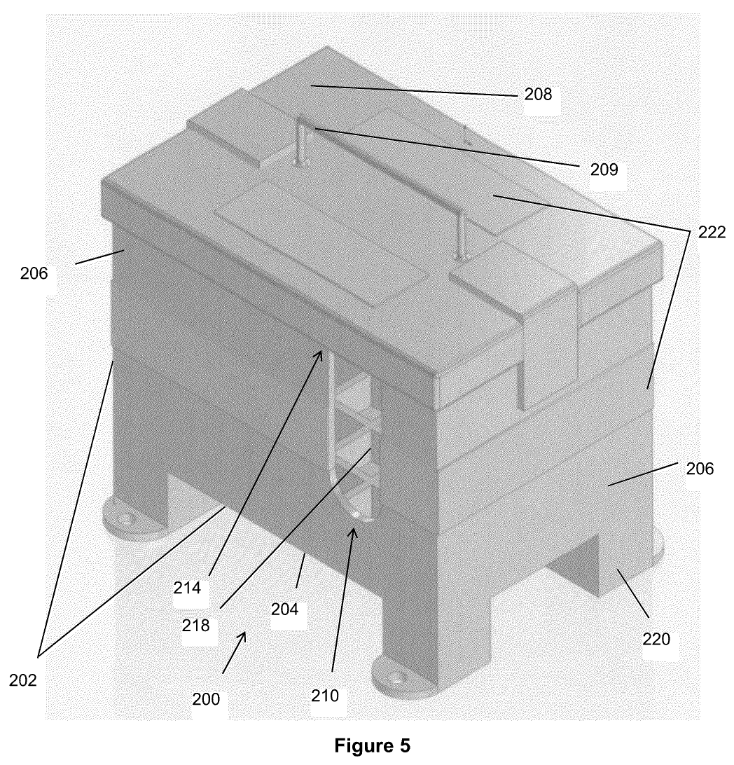

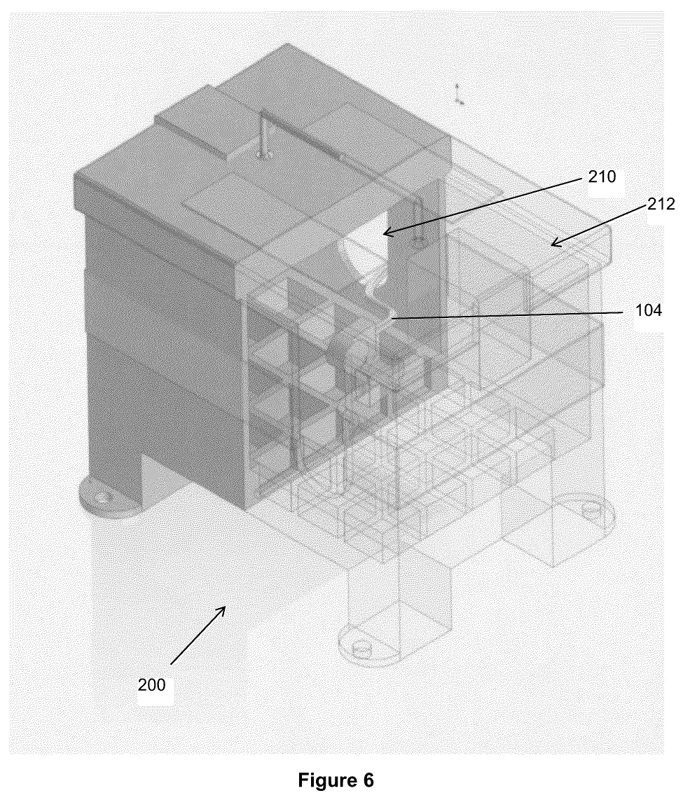

FIG. 5 is a schematic perspective view of a weather-resistant RV power cord connector housing 200 according to a first embodiment. FIG. 6 is a schematic perspective view showing a partial cutaway of the weather-resistant RV power cord connector housing 200 of FIG. 5.

The weather-resistant RV power cord connector housing 200 may include a box body 202 including a bottom 204 and sidewalls 206, and a lid 208. The bottom 204 of the box body 202 and the sidewalls 206 may define an inner area 212 (see FIG. 6) of the box body 202. The bottom 204 and the sidewalls 206 may be integral to each other.

In the embodiment shown in FIGS. 5 and 6, a total of four (4) sidewalls 206 may be provided. Openings 210 may be provided in some of the sidewalls 206. A first one of the sidewalls 206 may include a first opening 210, and a second one of the sidewalls 206 may include a second opening 210 (see FIG. 6). The first opening 210 may be offset from the second opening 210. The first opening 210 may be dimensioned to receive a portion of a first power cord (e.g., 102) and the second opening 210 may be dimensioned to receive a portion of a second power cord 104 (see FIG. 6). For example, the first opening 210 and the second opening 210 may each measure at least approximately 1½ inches wide so as to accommodate an approximately 1 ¼ inch thick power cord (50 amp) including any weather-resistant lining that may be provided. In an embodiment, the first opening 210 and the second opening 210 may have a width in a range of approximately 1½ inches to approximately 2 inches. The first opening 210 may extend to a top 214 of the first one of the sidewalls 206, and may be referred to as a slot. The second opening 210 may extend to a top 214 of the second one of the sidewalls 206, and may be referred to as another slot. As will be described with respect to another embodiment, the first opening 210 and the second opening 210 may each include a weather-resistant lining such as a brush seal.

The first opening 210 may be offset with respect to the second opening 210 to allow an S-shaped configuration (or junction) to fit in the inner space 212 rotated either of two directions. The slots (first and second openings) may include the brush seal such that it surrounds the power cords where they pass through the slots (i.e., the bristles may contact and cover the power cords). The brush seal may also allow the power cords to slide into and out of the slots.

To use the weather-resistant RV power cord connection housing 200, a user may connect a first power cord 102 connector and a second power cord 104 connector (and, if appropriate, a power converter 106) in an S-shaped configuration. The user may insert the S-shaped configuration (or junction) into the inner area 212 of the box body 202 by sliding the first power cord 102 into the first opening of the first one of the sidewalls 206 and sliding the second power cord 104 into the second opening of the second one of the sidewalls 206.

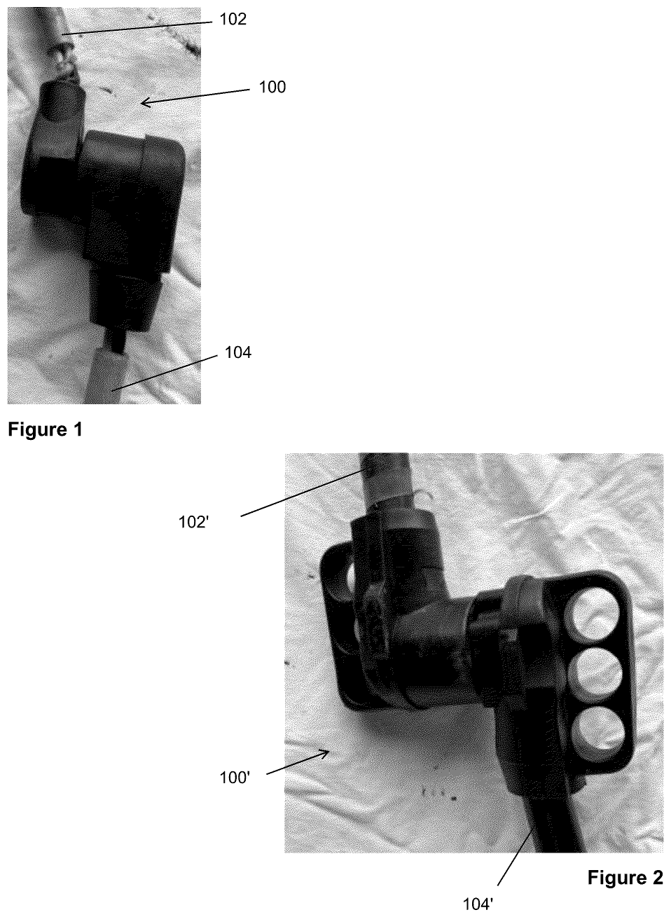

The inner area 212 of the box body 202 may be dimensioned to receive a connector plug of the first power cord 102 and a connector plug of the second power cord 104 that are physically and electrically connected to each other. For example, the inner area 212 may be dimensioned to receive two L-shaped connector plugs physically and electrically connected to each other such as is shown in FIGS. 1 and 2 in an S-shaped configuration. The inner area 212 of the box body 202 may be dimensioned to receive the connector plug of the first power cord 102 while being physically and electrically connected to a power converter 106 (e.g., a 30 Amp/50 Amp power converter) that is physically and electrically connected to the connector plug of the second power cord 104, also in an S-shaped configuration. The power cords leading away from the S-shaped configuration may be extended through the first opening 210 and the second opening 210, said openings being offset from each other in the first and second ones of the sidewalls 206 to correspond to the offset nature of the first power cord and the second power cord connected in the S-shaped configuration.

For example, in the embodiment of FIGS. 5 and 6, the weather-resistant RV power cord connector housing 200 may measure approximately 12 inches long by approximately 10 inches wide by approximately 10 inches deep. The first opening 210 and the second opening 210 may be offset from one another by at least approximately 2 inches. In an embodiment, the first opening 210 and the second opening 210 may be offset from one another by at least approximately 4 inches.

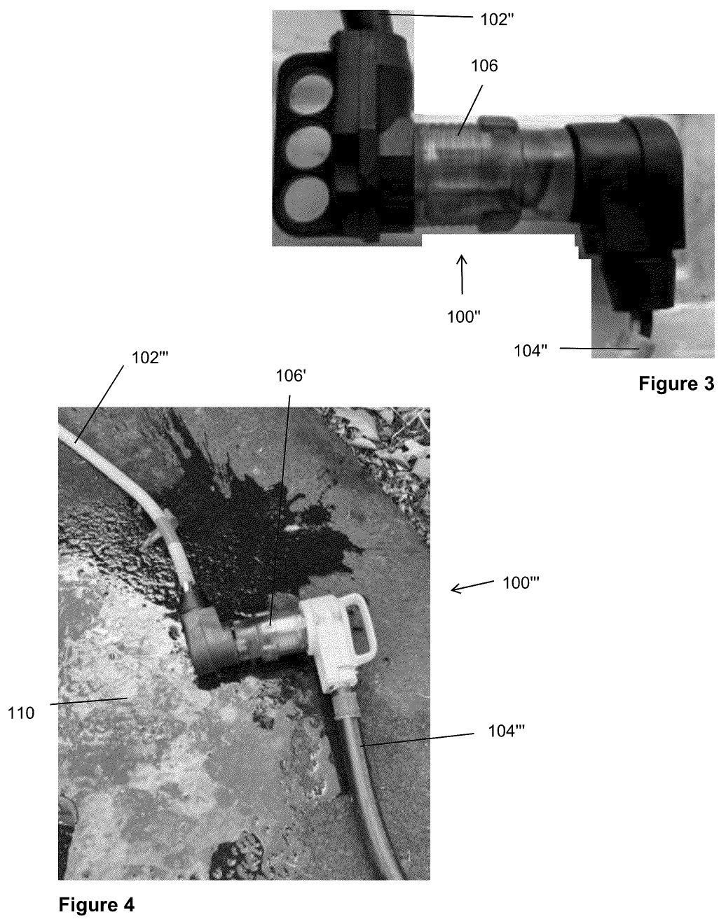

In the case of a 30 amp to 30 amp power cord junction 100 (FIG. 1), the junction 100 may measure approximately 3 inches wide. In the case of a 50 amp to 50 amp power cord junction 100′ (FIG. 2), the junction 100′ may measure approximately 5 inches wide. In the case of a 50 amp to 30 amp power cord junction 100″ (including power converter 106, FIG. 3), the junction 100″ may measure approximately 7 inches wide. Each of these junctions 100, 100′, 100″ may be received within the inner area 212 of the box body 202 of the weather-resistant RV power cord connector housing 200 measuring approximately 12 inches long by approximately 10 inches wide by approximately 10 inches deep.

In another embodiment, the inner space of the box body 202 may measure at least approximately 8 inches wide by at least approximately 6 inches long by at least approximately 4 inches tall.

The lid 208 may include a handle 209 to enable easy movement and placement of the weather-resistant RV power cord connector housing 200. The lid 208 may, in a closed state, cover the inner area 212 of the box body 202. The lid 208 may, in an open state, expose or provide access to the inner area 212. The lid 208 may be partially or fully removed from the top of the box body 212 (e.g., the lid 208 may be in the open state) and the inner area 212 of the box body 202 may receive a power cord junction. The lid 208 may be affixed to the top of the box body 202 (e.g., the lid 208 may be in the closed state) so as to enclose the power junction within the protected inner area 212. As will be described with respect to other embodiments, the lid 208 may be snapped into a closed state by snap assemblies or may rotate about a hinge and be fastened in the closed state by a snap assembly.

The weather-resistant RV power cord junction housing 200 may further include legs 220 (or foot pegs) extending from at least one of the bottom 204 of the box body 202 and the sidewalls 206 of the box body 202. The legs 220 may be at least ½ inch tall so as to elevate the bottom 204 of the box body 202 above ground level and out of any standing water. In an embodiment, the length of the legs top to bottom may be in a range of approximately 1 inch to approximately 3 inches.

The legs 220 may extend downward away from the box body 202. In an embodiment, the legs 220 may be integral to the box body 202. In another embodiment, the legs 220 may be attached to the box body 202. As shown, the legs may include foot extensions that each include a peg hole. The peg hole may be used to receive a stake or peg or nail so as to secure the weather-resistant RV power cord junction housing 200 to the ground or other surface.

One or more components of the weather-resistant RV power cord junction housing 200 may be formed from a non-conductive material such as a plastic. For example, the box body 202 including the bottom 204, the sidewalls 206, and the legs 220, and the lid 208 may be formed of a non-conductive material such as a plastic. As but one non-limiting example, the lid 208 and box body 220 may be formed using heavy-gauge thermoforming. As another non-limiting example, the lid and box body 220 may be formed using injection molding. The plastic may be at least ⅜ inches thick so as to withstand the forces (torque/twisting) resulting from the power cords 102, 104 when they are inserted into the first opening 210 and the second opening 210 (i.e., the slots), and when the weather-resistant RV power cord junction housing 200 may be moved.

While the design of the weather-resistant RV power cord junction housing 200 limits or even prevents ingress of moisture, the weather-resistant RV power cord junction housing 200 may further include at least one drain opening defined in the bottom 204 of the box body 202 dimensioned to drain fluid from the inner area 212. In another embodiment, the bottom 204 may alternatively or additionally include multiple recesses 218 defined therein. The recesses 218 may be provided by a grid structure or alternatively, by a raised platform. The recesses 218 may be dimensioned to hold fluid below and a distance from a resting position of the first power cord and the second power cord 104 (see FIG. 6). The embodiment of FIGS. 5 and 6 is shown as including multiple recesses 218. Even if a drain opening is not provided, water that may enter the inner area 212 may drain into the multiple recesses 218 so that the first power cord and the second power cord are elevated at least approximately ½ inch above bottoms of the recesses 218. That is, the first power cord and the second power cord may be elevated above any fluid that may find its way into the inner area 212. In other embodiments, a grid defining the recesses may not have a bottom and therefore, when coupled with the length of the legs 220, the first power cord and the second power cord may be at least approximately 1 inch above ground level.

High visibility indicia 222 may be provided to all or part of the weather-resistant RV power cord junction housing 200. The high visibility indicia 222 may increase visibility of the weather-resistant RV power cord junction housing 200, especially in the dark. For example, a brightly colored and/or reflective surface may be applied to sidewalls 206 and/or the lid 208, either by affixing a decal, by paint by die, or the like. Further, the high visibility indicia 222 may help to prevent unintended leaving behind of the weather-resistant RV power cord junction housing 200, or accidental running over by an RV.

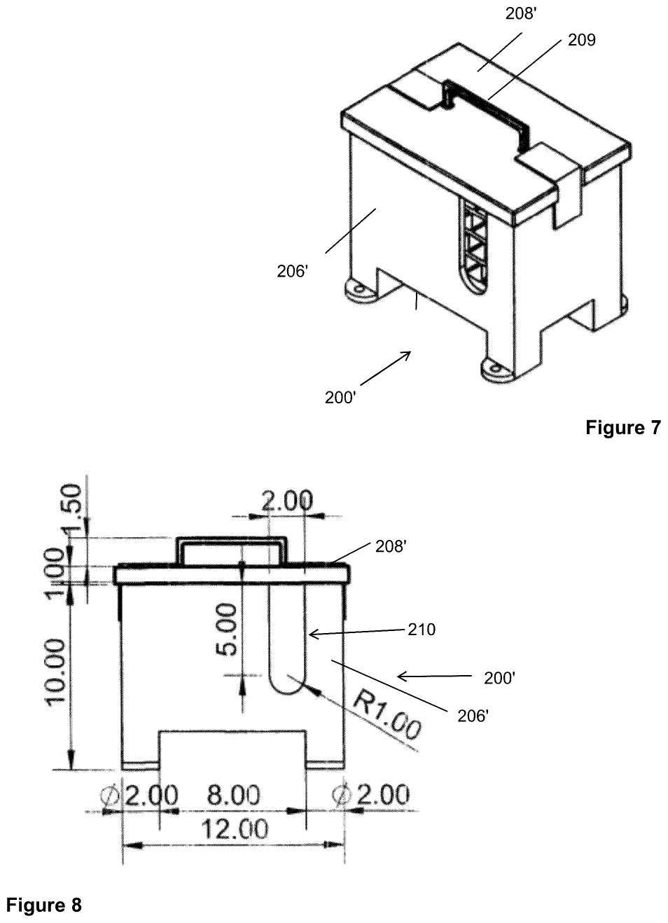

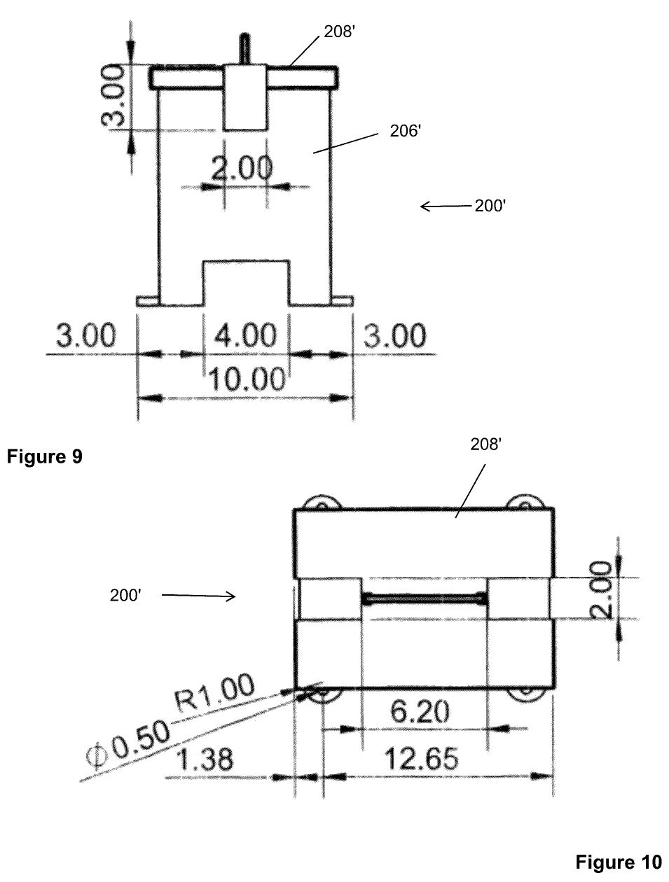

FIG. 7 is a schematic perspective view of a weather-resistant RV power cord connector housing 200′ according to a second embodiment. FIG. 8 is a schematic front view of the weather-resistant RV power cord connector housing 200′ of FIG. 7. FIG. 9 is a schematic side view of the weather-resistant RV power cord connector housing 200′ of FIG. 7. FIG. 10 is a schematic plan view of the weather-resistant RV power cord connector housing 200′ of FIG. 7.

Features of the weather-resistant RV power cord connector housing 200′ of FIGS. 7-10 may be substantially the same or similar to those of the embodiment described with respect to FIGS. 5 and 6 except for some differences discussed next. Accordingly, a redundant description of the elements that may be substantially the same or similar is omitted in the interest of brevity and clarity.

The weather-resistant RV power cord connector housing 200′ may include sidewalls 206′ and a lid 208′ that omit separate high visibility indicia 222. Rather, the sidewalls 206′ and/or lid 208′ may themselves be colored in a high visibility and/or reflective color. In other embodiments, the sidewall and lid may omit any high visibility aspect.

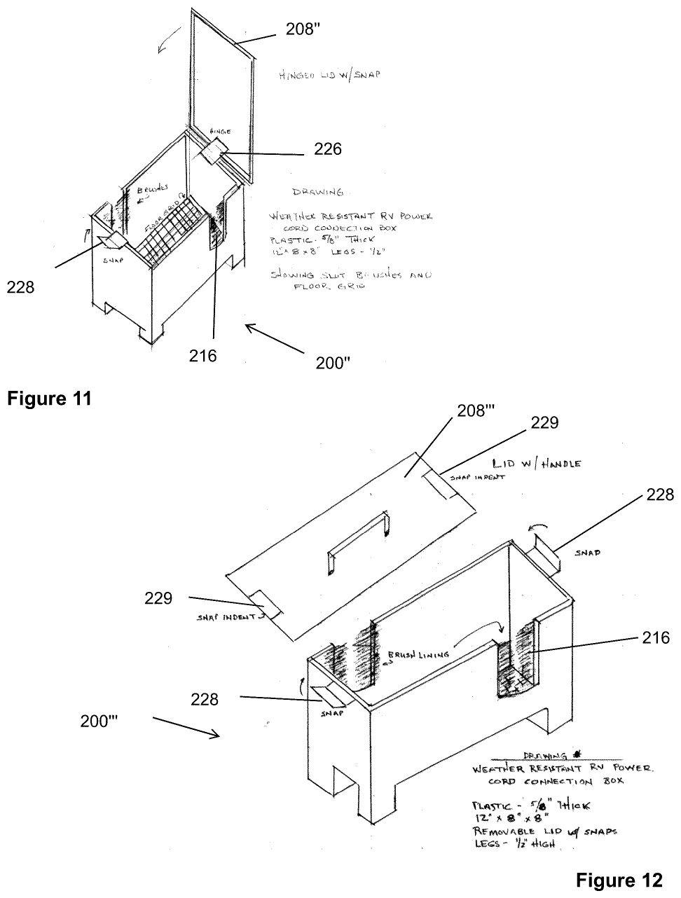

FIG. 11 is a schematic perspective view of a weather-resistant RV power cord connector 200″ housing according to a third embodiment.

Features of the weather-resistant RV power cord connector housing 200″ of FIG. 11 may be substantially the same or similar to those of the embodiment described with respect to FIGS. 5 and 6 except for some differences discussed next. Accordingly, a redundant description of the elements that may be substantially the same or similar is omitted in the interest of brevity and clarity.

The weather-resistant RV power cord connector housing 200″ may include a hinge 226 attached to the box body 202 and the lid 208″, and a snap assembly 228. Note that the hinge 226 may be attached to a sidewall 206 not including the slots (i.e., the first opening and the second opening). This is so that the hinge 228 and attached lid 208″ do not interfere with the function of the slots (receiving power cords). The lid 208″ may rotate about the hinge 226 between an open state and a closed state. The snap assembly 228 may engage the lid 208″ to secure the lid in the closed state.

The weather-resistant RV power cord connector housing 200″ may include a weather-resistant lining 216 along the edges of the first opening 210 and the second opening 210. For example, the weather-resistant lining 216 may be a brush seal. While the brush seal may not be absolutely waterproof, the brush seal may offer a balance of effectiveness and usability. That is, the brush seal may excel at keeping dirt, dust, water, and debris from passing through the slots (first and second openings 210) and into the inner area 212, but may also excel at providing usability with respect to sliding power cords 102 and 104 in and out of their respective slots.

FIG. 12 is a schematic perspective view of a weather-resistant RV power cord connector housing according to a fourth embodiment.

Features of the weather-resistant RV power cord connector housing 200′″ of FIG. 12 may be substantially the same or similar to those of the embodiments described with respect to FIGS. 5, 6 and 11 except for some differences discussed next. Accordingly, a redundant description of the elements that may be substantially the same or similar is omitted in the interest of brevity and clarity.

The weather-resistant RV power cord connector housing 200′″ may include two snap assemblies 228 attached to the box body 202, and that may engage the lid 208″′ in a closed state. Specifically, the lid 208″′ may include an indentation to receive a portion of the snap assembly and secure the lid. In an open state, the lid 208′″ may be removable from the box body 202.

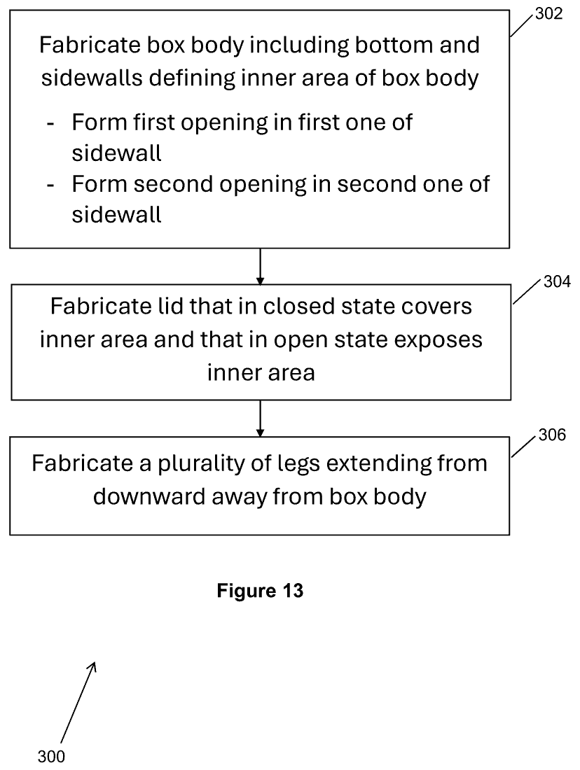

FIG. 13 is a flow chart of a method 300 of manufacture of a weather-resistant RV power cord junction housing according to an embodiment.

The method 300 may include the operation 302 of fabricating a box body (e.g., 202) including a bottom (e.g., 204) and sidewalls (e.g., 206), the bottom and the sidewalls defining an inner area (e.g., 212) of the box body, and the operation 304 of fabricating a lid (e.g., 208) that in a closed sate covers the inner area of the box body and that in an open state exposes the inner area of the box body.

The operation 302 of fabricating the box body may include forming a first opening (e.g., 210) in a first one of the sidewalls (e.g., 206), and forming a second opening (e.g., 210) in a second one of the sidewalls (e.g., 206). The first one of the sidewalls may be formed to face the second one of the sidewalls. The first opening may be formed to be offset from the second opening. The first opening may be dimensioned to receive a portion of a first power cord (e.g., 102), and the second opening may be dimensioned to receive a portion of a second power cord (e.g., 104). The first opening may be formed to extend to a top of the first one of the sidewalls and may include a weather-resistant lining, and the second opening may be formed to extend to the top of the second one of the sidewalls and may include a weather-resistant lining.

The operation 302 of fabricating the box body may include dimensioning the inner area (e.g., 212) of the box body to receive an L-shaped connector plug of the first power cord and an L-shaped connector plug of the second power cord that are physically and electrically connected to each other in an S-shaped configuration. The operation 302 of fabricating the box body may include dimensioning the inner area of the box body to receive the L-shaped connector plug of the first power cord while being physically and electrically connected to a power converter (e.g., 106) that is physically and electrically connected to the L-shaped connector plug of the second power cord, also in an S-shaped configuration.

The method 300 may further include the operation 306 of fabricating legs (e.g., 220) to extend from at least one of the bottom (e.g., 204) of the box body (e.g., 202) and the sidewalls (e.g., 206) of the box body. The legs may be formed to extend downward away from the box body. In an embodiment, the legs may be formed integrally with the box body. In another embodiment, the legs may be attached to the box body.

The operations 302, 304, and 306 may include fabricating the box body, the lid, and/or the legs from a non-conductive material such as a plastic.

According to embodiments, a weather-resistant RV power cord connector housing may be provided along with a method of manufacture thereof. The weather-resistant RV power cord connector housing may provide desirable and even life-saving benefits. For example, a junction between two power cords may be secured within a weather-resistant enclosure, thereby reducing or even eliminating the risk of electric shock. Further, the weather-resistant RV power cord connector housing may protect metal components of power cords from dirt and corrosion, and also from tampering by others. The weather-resistant RV power cord connector housing may be relatively low cost for consumers, and may be easily stored (e.g., in a power cord compartment of an RV). According to the method of manufacture, cost-effective and efficient manufacture of such a weather-resistant RV power cord connector housing is provided. Additional benefits are provided herein.

Embodiments have been disclosed herein, and although terms are employed, they are used and are to be interpreted in a generic and descriptive sense only and not for purposes of limitation. In some instances, as would be apparent by one of ordinary skill in the art, features and characteristics described in connection with an embodiment may be used singly or in combination with features and characteristics described in connection with other embodiments unless otherwise specifically indicated. Accordingly, it will be understood by those of ordinary skill in the art that various changes in form and details may be made without departing from the spirit and scope of the disclosure as set forth herein.

What is claimed is:

1. A weather-resistant RV power cord junction housing, comprising:
a box body including a bottom and a plurality of sidewalls, the bottom and the plurality of sidewalls defining an inner area of the box body; and
a lid that in a closed state covers the inner area of the box body and that in an open state exposes the inner area of the box body, wherein
a first one of the plurality of sidewalls includes a first opening,
a second one of the plurality of sidewalls includes a second opening,
the first one of the plurality of sidewalls faces the second one of the plurality of sidewalls,
the first opening is offset from the second opening,
the first opening is dimensioned to receive a portion of a first power cord, and
the second opening is dimensioned to receive a portion of a second power cord.

2. The weather-resistant RV power cord junction housing of claim 1, wherein the inner area of the box body is dimensioned to receive a connector plug of the first power cord and a connector plug of the second power cord, the connector plug of the first power cord being physically and electrically connected to the connector plug of the second power cord.

3. The weather-resistant RV power cord junction housing of claim 2, wherein the connector plug of the first power cord is an L-shaped connector plug, and the connector plug of the second power cord is an L-shaped connector plug.

4. The weather-resistant RV power cord junction housing of claim 1, wherein the inner area of the box body is dimensioned to receive a connector plug of the first power cord, a connector plug of the second power cord, and a power converter, the connector plug of the first power cord being physically and electrically connected to the power converter, the power converter being physically and electrically connected to the connector plug of the second power cord.

5. The weather-resistant RV power cord junction housing of claim 1, wherein the first opening extends to a top of the first one of the plurality of sidewalls, and the second opening extends to a top of the second one of the plurality of sidewalls.

6. The weather-resistant RV power cord junction housing of claim 1, wherein the first opening includes a weather-resistant lining, and the second opening includes a weather-resistant lining.

7. The weather-resistant RV power cord junction housing of claim 6, wherein the weather-resistant lining includes a brush seal.

8. The weather-resistant RV power cord junction housing of claim 1, further comprising:
at least one drain opening in the bottom of the box body, the at least one drain opening in the bottom dimensioned to drain fluid from the inner area of the box body.

9. The weather-resistant RV power cord junction housing of claim 1, further comprising:
a plurality of recesses in the bottom of the box body, the plurality of recesses in the bottom dimensioned to hold fluid below and a distance from a resting position of the first power cord and a resting position of the second power cord.

10. The weather-resistant RV power cord junction housing of claim 1, wherein the bottom, the lid, and plurality of sidewalls are formed from a non-conductive material.

11. The weather-resistant RV power cord junction housing of claim 10, wherein the non-conductive material includes plastic.

12. The weather-resistant RV power cord junction housing of claim 1, further comprising:
a plurality of legs extending from at least one of the bottom of the box body and the plurality of sidewalls of the box body, the plurality of legs extending downward away from the box body.

13. The weather-resistant RV power cord junction housing of claim 12, wherein the plurality of legs, the bottom, and the plurality of sidewalls are integral to each other.

14. The weather-resistant RV power cord junction housing of claim 1, wherein at least one of the lid and the plurality of sidewalls includes a high-visibility indicia.

15. A method of manufacture of a weather-resistant RV power cord junction housing, the method comprising:
fabricating a box body including a bottom and a plurality of sidewalls, the bottom and the plurality of sidewalls defining an inner area of the box body; and
fabricating a lid that in a closed state covers the inner area of the box body and that in an open state exposes the inner area of the box body, wherein
the fabricating of the box body including the bottom and the plurality of sidewalls includes:
forming a first opening in a first one of the plurality of sidewalls, and
forming a second opening in a second one of the plurality of sidewalls,
the first one of the plurality of sidewalls faces the second one of the plurality of sidewalls,
the first opening is offset from the second opening,
the first opening is dimensioned to receive a portion of a first power cord, and
the second opening is dimensioned to receive a portion of a second power cord.

16. The method of manufacture of claim 15, wherein the fabricating of the box body including the bottom and the plurality of sidewalls includes dimensioning the inner area of the box body to receive an L-shaped connector plug of the first power cord and an L-shaped connector plug of the second power cord, the L-shaped connector plug of the first power cord being physically and electrically connected to the L-shaped connector plug of the second power cord.

17. The method of manufacture of claim 15, wherein the fabricating of the box body including the bottom and the plurality of sidewalls includes dimensioning the inner area of the box body to receive an L-shaped connector plug of the first power cord, an L-shaped connector plug of the second power cord, and a power converter, the L-shaped connector plug of the first power cord being physically and electrically connected to the power converter, the power converter being physically and electrically connected to the L-shaped connector plug of the second power cord.

18. The method of manufacture of claim 15, wherein the first opening extends to a top of the first one of the plurality of sidewalls and includes a weather-resistant lining, and the second opening extends to a top of the second one of the plurality of sidewalls and includes a weather-resistant lining.

19. The method of manufacture of claim 15, wherein the fabricating of the box body and the fabricating of the lid include fabricating the box body from a non-conductive material and fabricating the lid from a non-conductive material.

20. The method of manufacture of claim 15, further comprising fabricating a plurality of legs extending from at least one of the bottom of the box body and the plurality of sidewalls of the box body, the plurality of legs fabricated to extend downward away from the box body.
